(19) United States
(12) Patent Application Publication
(10) Pub. No.: US 2006/0103123 A1
(43) Pub. Date: May 18, 2006

(54) Inflator with shock wave focusing structure

(75) Inventor: James A. Myers, Gilbert, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 10/987,975

(22) Filed: Nov. 12, 2004

(51) Int. Cl. B60R 21/26

(52) U.S. Cl. 280/736; 280/737; 280/740

(57) ABSTRACT

An inflator (12) includes a container (38) having a fluid storage chamber (110). The chamber (110) includes opposite first and second ends (102 and 104). A fluid (112) is stored under pressure in the chamber (110). A shock wave generator (116) is located adjacent the first end (102) of the chamber (110). The shock wave generator (116), when actuated, produces a shock wave that propagates through the chamber (110) toward the second end (104). A fluid outlet passage (100) is located at the second end (104) of the chamber (110). A burst disk (128) closes the passage (100). The chamber (110) gradually decreases in cross-sectional area adjacent the second end (104) so that the shock wave produced by actuation of the shock wave generator (116) is directed against the burst disk (128) and ruptures the burst disk (128).

### TECHNICAL FIELD

The present invention relates to an inflator, and particularly to an inflator for use in inflating an inflatable vehicle occupant protection device.

### BACKGROUND OF THE INVENTION

A conventional inflator for inflating an inflatable vehicle occupant protection device includes a container having a storage chamber. Inflation fluid under pressure is stored in the storage chamber. A burst disk closes an opening in the storage chamber. An initiator is located adjacent to the burst disk. The initiator is actuatable to rupture the burst disk.

It is common for the initiator of the inflator to be located outside of the storage chamber. This is particularly common in cold gas inflators, i.e., inflators in which little or no heat is transferred to the inflation fluid stored in the chamber. When inflation of the vehicle occupant protection device is desired, the initiator of the inflator is actuated. Actuation of the initiator ruptures the adjacent burst disk and enables the fluid to exit the chamber.

It is common in augment and heated gas type inflators to locate the initiator at an opposite end of the chamber from the burst disk. Actuation of the initiator results in either heating of inflation fluid stored in the chamber under pressure or ignition of a propellant material to generate additional inflation fluid. In either case, fluid pressure within the chamber increases. As the pressure within the chamber increases, a pressure differential across the burst disk increases. When the pressure differential reaches a predetermined value, the burst disk ruptures and fluid flows out of the chamber toward the vehicle occupant protection device.

### SUMMARY OF THE INVENTION

The present invention relates to an inflator comprising a container having a fluid storage chamber. The chamber includes opposite first and second ends. A fluid is stored under pressure in the chamber. The inflator also comprises a shock wave generator that is located adjacent the first end of the chamber. The shock wave generator, when actuated, produces a shock wave that propagates through the chamber toward the second end. A fluid outlet passage is located at the second end of the chamber. A burst disk closes the fluid outlet passage. The chamber gradually decreases in cross-sectional area adjacent the second end so that the shock wave produced by actuation of the shock wave generator is directed against the burst disk and ruptures the burst disk, thus enabling fluid flow out of the chamber through the fluid outlet passage.

According to another aspect, the present invention relates to an inflator comprising a container having a fluid storage chamber and a fluid outlet passage that is connected to the chamber. A burst disk closes the outlet passage. A fluid is stored under pressure in the chamber. The inflator also includes means for rupturing the burst disk. The means for rupturing the burst disk consists of a shock wave generator for producing a shock wave to rupture the burst disk and means for focusing the shock wave against the burst disk.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a vehicle safety system including an inflator constructed in accordance with the present invention;

FIG. 2 illustrates an inflator constructed in accordance with a first embodiment of the present invention;

FIG. 3 illustrates an inflator constructed in accordance with a second embodiment of the present invention; and

FIG. 4 illustrates an inflator constructed in accordance with a third embodiment of the present invention.

### DETAILED DESCRIPTION OF THE INVENTION

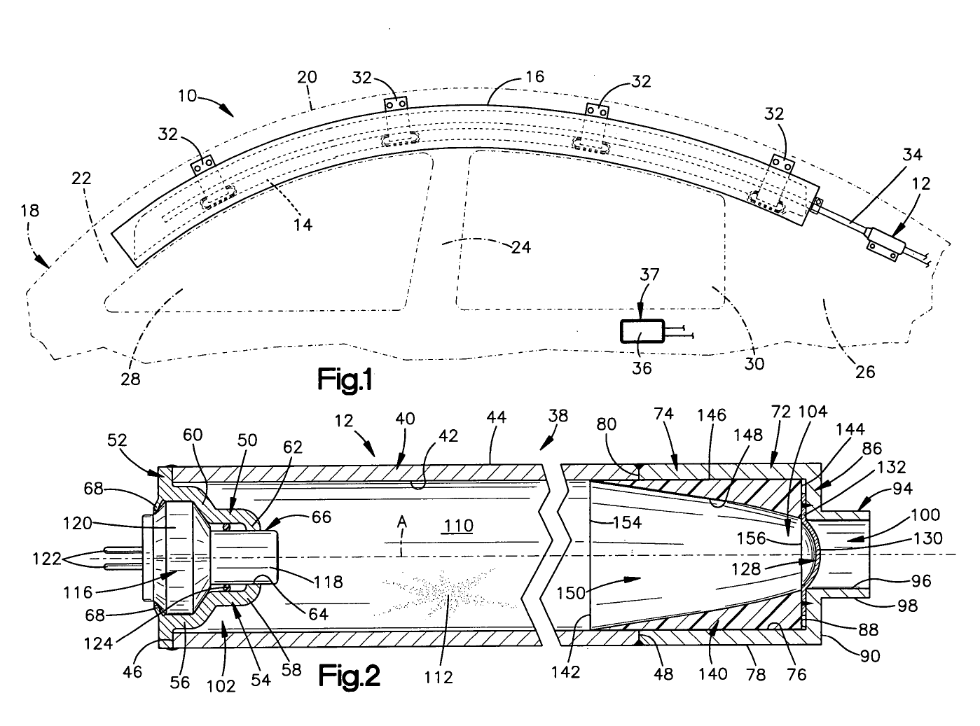

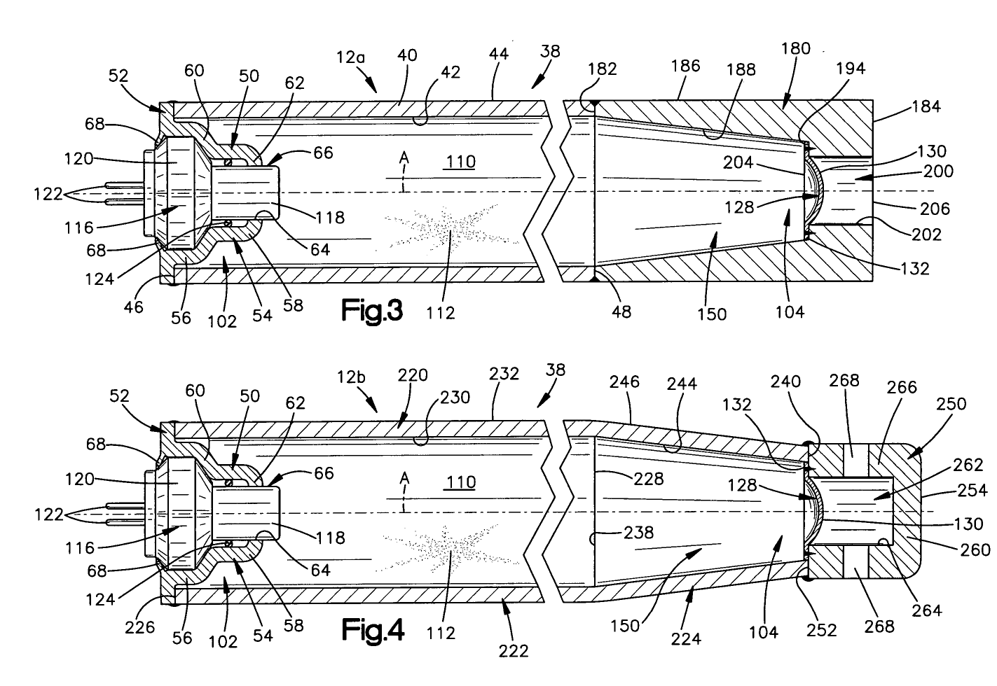

FIG. 1 illustrates a vehicle safety system 10 including an inflator 12 constructed in accordance with the present invention. The inflator 12 of the present invention is used to inflate an inflatable vehicle occupant protection device of the vehicle safety system 10. The inflatable vehicle occupant protection device of FIG. 1 is an inflatable curtain 14. Alternatively, the inflatable vehicle occupant protection device may include an inflatable air bag, an inflatable seat belt, an inflatable knee bolster, an inflatable headliner, or a knee bolster operated by an inflatable air bag.

The inflatable curtain 14 of FIG. 1 is stored in a deflated condition within a housing 16. The inflatable curtain 14, in the deflated condition, and the housing 16 have an elongated configuration and are mounted to a vehicle 18 in a location adjacent both the side structure of the vehicle and a roof 20 of the vehicle. The side structure of the vehicle 18 includes an A-pillar 22, a B-pillar 24, a C-pillar 26, and side windows 28 and 30. FIG. 1 shows four brackets 32 securing the housing 16 and the inflatable curtain 14 to the side structure of the vehicle 18.

In the illustrated embodiment, a fill tube 34 connects the inflator 12 to the inflatable curtain 14. The inflator 12 is in fluid communication with the inflatable curtain 14 through the fill tube 34. Upon actuation of the inflator 12, inflation fluid flows through the fill tube 34 and into the inflatable curtain 14. In response to receiving the inflation fluid, the inflatable curtain 14 deploys from the deflated condition to an inflated condition to cover portions of the side structure of the vehicle, such as the side windows 28 and 30.

The vehicle safety system 10 also includes a sensor 36 for sensing a deployment condition for which inflation of the inflatable curtain 14 is desired. The sensor 36 forms a portion of the electronic circuitry 37 of the vehicle safety system 10. When the sensor 36 senses a deployment condition for which inflation of the inflatable curtain 14 is desired, the electronic circuitry 37 of the vehicle safety system 10 actuates the inflator 12 to provide inflation fluid to the inflatable curtain 14.

FIG. 2 is a sectional view of an inflator 12 constructed in accordance with a first embodiment of the present invention. The inflator 12 includes an elongated container 38. The container 38 includes a tubular metal body portion 40. The body portion 40 includes cylindrical inner and outer surfaces 42 and 44, respectively. The inner and outer surfaces 42 and 44 are centered on axis A. The body portion 40 of the inflator 12 also has opposite first and second open ends 46 and 48, respectively.

The container 38 also includes an initiator retainer 50. The initiator retainer 50 closes the first open end 46 of the body portion 40. The initiator retainer 50 includes an annular, radially extending peripheral portion 52. An outer diameter of the peripheral portion 52 of the initiator retainer 50 is approximately equal to the diameter of the outer surface 44 of the body portion 40. The peripheral portion 52 of the initiator retainer 50 is affixed to the body portion 40 at the first open end 46. FIG. 2 shows the peripheral portion 52 of the initiator retainer 50 welded to the body portion 40 at the first open end 46.

The initiator retainer 50 also includes an axially protruding central portion 54. The central portion 54 includes first and second annular, axially extending sections 56 and 58, respectively. The first annular, axially extending section 56 is disposed adjacent to the peripheral portion 52 and has a diameter that is greater than a diameter of the second annular, axially extending section 58. A tapered section 60 connects the first and second annular, axially extending sections 56 and 58. A central flange 62 extends radially inwardly from an end of the second annular, axially extending section 58 opposite the tapered section 60. A radially inner surface 64 of the central flange 62 defines an opening 66 that extends axially through the central portion 54 of the initiator retainer 50.

The initiator retainer 50 also includes a plurality of retaining tabs 68. Two of the retaining tabs 68 are shown in FIG. 2. Each retaining tab 68 may be bent from an axially extending position (not shown) to a position extending radially inwardly relative to the peripheral portion 52 of the initiator retainer 50, as shown in FIG. 2.

The container 38 also includes a diffuser endcap 72. The diffuser endcap 72 closes the second open end 48 of the body portion 40. The diffuser endcap 72 includes a tubular end portion 74. The tubular end portion 74 includes inner and outer surfaces 76 and 78, respectively. The outer surface 78 of the tubular end portion 74 of the diffuser endcap 72 has a diameter that is equal to the diameter of the outer surface 44 of the body portion 40. An annular end surface 80 of the tubular end portion 74 of the diffuser endcap 72 connects the inner and outer surfaces 76 and 78. The annular end surface 80 is affixed to the second open end 48 of the body portion 40. FIG. 2 shows the annular end surface 80 of the diffuser endcap 72 welded to the second open end 48 of the body portion 40.

An annular wall portion 86 of the diffuser endcap 72 extends radially inwardly from the tubular end portion 74 at an end of the tubular end portion opposite end surface 80. The annular wall portion 86 includes inner and outer surfaces 88 and 90, respectively. The inner surface 88 of the annular wall portion 86 joins with and extends perpendicular to the inner surface 76 of the tubular end portion 74 of the diffuser endcap 72. The outer surface 90 of the annular wall portion 86 joins with and extends perpendicular to the outer surface 78 of the tubular end portion 74 of the diffuser endcap 72.

A tubular discharge portion 94 of the diffuser endcap 72 extends axially away from the annular wall portion 86 in a direction opposite the tubular end portion 74. The tubular discharge portion 94 includes cylindrical inner and outer surfaces 96 and 98, respectively. The inner surface 96 of the tubular discharge portion 94 joins with and extends perpendicular to inner surface 88 of the annular wall portion 86. The inner surface 96 has a diameter that is approximately half the diameter of the inner surface 76 of the tubular end portion 74. The inner surface 96 of the tubular discharge portion 94 defines a fluid outlet passage 100. The outer surface 98 of the tubular discharge portion 94 joins with and extends perpendicular to the outer surface 90 of the annular wall portion 86.

A fluid storage chamber 110 is located within the container 38. The chamber 110 extends axially along axis A between the initiator retainer 50 and the annular wall portion 86 of the diffuser endcap 72. A first end 102 of the chamber 110 is located adjacent the initiator retainer 50 and a second end 104 is located adjacent the annular wall portion 86 of the diffuser endcap 72. The fluid outlet passage 100 is disposed adjacent to the second end 104 of the chamber 110 so that fluid communication between the fluid outlet passage and the chamber is possible, as described below.

A fluid 112 under pressure is stored in the chamber 110. Preferably, the fluid 112 is one or more inert gases, such as helium, argon, or nitrogen, and is free of any pyrotechnic or heat-generating elements.

The inflator 12 also includes a shock wave generator. The shock wave generator may be any device that is actuatable for generating a shock wave. In the inflator 12 of FIG. 2, the shock wave generator is an actuatable initiator 116. The initiator 116 includes a portion 118 containing a pyrotechnic material (not shown) and a resistive wire (not shown) for igniting the pyrotechnic material. The initiator 116 also includes a generally cylindrical support portion 120. Leads 122 of the initiator 116 extend outwardly of the support portion 120 in a direction opposite the portion 118. The leads 122 enable the initiator 116 to be connected to the electronic circuitry 37 (FIG. 1) of the vehicle safety system 10.

The initiator 116 is received in and supported by the initiator retainer 50. When received in the initiator retainer 50, the support portion 120 of the initiator 116 is interposed between the tapered section 60 of the central portion 54 of the initiator retainer 50 and the retaining tabs 68. The portion 118 of the initiator 116 extends axially through the opening 66 of the initiator retainer 50. An O-ring 124 encircles the portion 118 of the initiator 116 adjacent the second annular, axially extending section 58 of the initiator retainer 50. The O-ring 124 serves two purposes. Firstly, the O-ring 124 supports the portion 118 of the initiator 116 relative to the second annular, axially extending section 58 of the initiator retainer 50. Secondly, the O-ring 124 forms a seal between the initiator 116 and the initiator retainer 50 for preventing fluid 112 from exiting the chamber 110 through the initiator retainer 50.

When the initiator 116 receives an actuation signal from the electronic circuitry 37 of the vehicle safety system 10, the pyrotechnic material of the portion 118 of the initiator 116 is ignited and a shock wave is produced. The shock wave is a large amplitude compression wave that propagates through the fluid 112. The shock wave includes a high pressure leading edge.

A metal burst disk 128 of the inflator 12 closes the outlet passage 100 of the diffuser endcap 72. The burst disk 128 has a domed central portion 130 and a radially outwardly extending flange portion 132 that is affixed to the inner surface 88 of the annular wall portion 86 of the diffuser endcap 72. Preferably, the flange portion 32 of the burst disk 128 is welded to the annular wall portion 86. When the flange portion 132 of the burst disk 128 is affixed to the inner surface 88 of the annular wall portion 86, the domed central portion 130 of the burst disk 128 closes the outlet passage 100 so as to prevent fluid 112 from exiting the chamber 110 through the outlet passage. The domed central portion of the burst disk 128 is designed to rupture when acted upon by the shock wave produced from actuation of the initiator 116.

The inflator 12 also includes a shock wave focusing device 140. The shock wave focusing device 140 may be formed from either a plastic or a metal material. The shock wave focusing device 140 illustrated in FIG. 2 is formed from plastic.

The shock wave focusing device 140 has opposite first and second ends 142 and 144, respectively. The shock wave focusing device 140 also includes outer and inner surfaces 146 and 148, respectively. The outer surface 146 is cylindrical and has a diameter that is approximately equal to the diameter of the inner surface 76 of the tubular end portion 74 of the diffuser endcap 72. The inner surface 148 of the shock wave focusing device 140 narrows relative to the outer surface 146 as it extends from the first end 142 to the second end 144. The inner surface 148 may be angled relative to the outer surface 146 at a constant angle or may be a smooth, curved surface. The inner surface 148 of the shock wave focusing device 140 is free from any portions that are angled sharply relative to the outer surface 146 so as to reflect the shock wave back toward the first end 142 of the shock wave focusing device.

The inner surface 148 of the shock wave focusing device 140 defines a tapered portion 150 of the chamber 110. The tapered portion 150 of the chamber 110 narrows toward the second end 144 of the shock wave focusing device 140. In the embodiment illustrated in FIG. 2, an end 154 of the tapered portion 150 of the chamber 110 that is located at the first end 142 of the shock wave focusing device 140 has a cross-sectional area that is approximately twice the cross-sectional area of an opposite end 156 of the tapered portion 150 located at the second end 144 of the shock wave focusing device 140.

The shock wave focusing device 140 is fixed in the tubular end portion 74 of the diffuser endcap 72 at a location adjacent the burst disk 128. Preferably, the second end 144 of the shock wave focusing device 140 abuts a side of the burst disk 128 opposite the annular wall portion 86 of the diffuser endcap 72. An adhesive may be used to affix the outer surface 146 of the shock wave focusing device 140 to the inner surface 76 of the tubular end portion 74 of the diffuser endcap 72. Alternatively, the shock wave focusing device 140 may be press fit into tubular end portion 74 of the diffuser endcap 72, or may be mechanically attached to the diffuser endcap 72. When the shock wave focusing device 140 is fixed at the location adjacent the burst disk 128, the end 156 of the tapered portion 150 of the chamber 110 is immediately adjacent the domed central portion 130 of the burst disk 128.

Upon actuation of the initiator 116, the shock wave propagates axially through the chamber 110 of the container 12 from the initiator 116 toward the burst disk 128. When the shock wave reaches the first end 142 of the shock wave focusing device 140, the shock wave enters the tapered portion 150 of the chamber 110. As the shock wave propagates through the tapered portion 150 toward the burst disk 128, the cross-sectional area of the chamber 110 gradually decreases. As a result of the decreasing cross-sectional area, the intensity of the shock wave increases.

The shock wave exits the shock wave focusing device 140 through the end 156 on the second end 144 and is directed into the domed central portion 130 of the burst disk 128. The shock wave ruptures the domed central portion 130 of the burst disk 128 and creates a flow opening (not shown) in the burst disk. Fluid 112 flows through the flow opening in the burst disk 128 and through the outlet passage 100 of the tubular discharge portion 94 of the diffuser endcap 72 to exit the inflator 12.

FIG. 3 illustrates an inflator 12a constructed in accordance with a second embodiment of the present invention. Structures of the inflator 12a of FIG. 3 that are the same or similar to structures of the inflator 12 of FIG. 2 are indicated using the same reference numbers.

The container 38 of the inflator 12a of FIG. 3 includes a diffuser endcap 180 having an open end 182 and a closed end 184. The diffuser endcap 180 also includes a cylindrical outer surface 186. The outer surface 186 has a diameter that is equal to the diameter of the outer surface 44 of the body portion 40. The open end 182 of the diffuser endcap 180 is fixed to the second open end 48 of the body portion 40. FIG. 3 illustrates the open end 182 of the diffuser endcap 180 welded to the second open end 48 of the body portion 40.

The diffuser end cap 180 also includes a tapered inner surface 188 that defines the tapered portion 150 of the chamber 110. The tapered portion 150 of the chamber 110 narrows as it extends axially away from the open end 182 of the diffuser endcap 180 and toward the closed end 184. An annular, radially extending surface 194 defines an end of the tapered portion 150 of the chamber 110 opposite the open end 182 of the diffuser endcap 180. The tapered portion 150 extends axially through approximately three-quarters of the axial length of the diffuser endcap 180 before terminating at the annular, radially extending surface 194.

The tapered portion 150 of the chamber 110, adjacent the open end 182 of the diffuser endcap 180, has a cross-sectional area that is equal to the cross-sectional area of the chamber 110 defined by the inner surface 42 of the body portion 40. The tapered portion 150 adjacent the annular, radially extending surface 194 has a cross-sectional area that is approximately two-thirds the cross-sectional area of the tapered portion 150 adjacent the open end 182.

An outlet passage 200 extends axially through the diffuser endcap 180 from the annular, radially extending surface 194 to the closed end 184. The outlet passage 200 is defined by a cylindrical surface 202. A first opening 204 of the outlet passage 200 is located on the annular, radially extending surface 194. A second opening 206 of the outlet passage 200 is located on the closed end 184 of the diffuser endcap 180.

A metal burst disk 128 of the inflator 12a closes the first opening 204 of the outlet passage 200 so as to prevent fluid 112 from exiting the chamber 110 through the outlet passage 200. The burst disk 128 has a cross-sectional area that is approximately equal to the cross-sectional area of the tapered portion 150 of the chamber 110 in a location adjacent the annular, radially extending surface 194. The burst disk 128 has a domed central portion 130 and a radially outwardly extending flange portion 132 that is affixed to the annular, radially extending surface 194 of the diffuser endcap 180. Preferably, the burst disk 128 is welded to the annular, radially extending surface 194.

The burst disk 128 is designed to rupture when acted upon by the shock wave produced from actuation of the initiator 116. The inner surface 188 of the diffuser endcap 180, by decreasing the cross-sectional area of the chamber 110 in the portion 150, acts to intensify the shock wave and to direct the shock wave into the burst disk 128. The shock wave ruptures the domed central portion 130 of the burst disk 128 and creates a flow opening (not shown) in the burst disk. Fluid 112 flows through the flow opening in the burst disk 128 and through the outlet passage 200 of the diffuser endcap 180 to exit the inflator 12a.

FIG. 4 illustrates an inflator 12b constructed in accordance with a third embodiment of the present invention. Structures of the inflator 12b of FIG. 4 that are the same or similar to structures of the inflator 12 of FIG. 2 are indicated using the same reference numbers.

The container 38 of the inflator 12b of FIG. 4 includes a body portion 220 that includes a cylindrical portion 222 and a frustoconical portion 224. The cylindrical portion 222 of the body portion 220 includes opposite first and second open ends 226 and 228, respectively, and cylindrical inner and outer surfaces 230 and 232, respectively.

The frustoconical portion 224 of the body portion 220 includes opposite wide and narrow ends 238 and 240, respectively. The wide end 238 is located adjacent to the second open end 228 of the cylindrical portion 222. The frustoconical portion 224 also includes inner and outer surfaces 244 and 246, respectively. The inner surface 244 of the frustoconical portion 224 merges with and extends axially and radially inwardly from the inner surface 230 of the cylindrical portion 222. The outer surface 246 merges with and extends axially and radially inwardly from the outer surface 232 of the cylindrical portion 222.

The inner surface 244 of the frustoconical portion 224 defines the tapered portion 150 of the chamber 110. The tapered portion 150 narrows as it extends axially from the wide end 238 of the frustoconical portion 224 to the narrow end 240. The cross-sectional area of the tapered portion 150 of the chamber 110 adjacent the narrow end 240 of the frustoconical portion 224 is approximately two-thirds the cross-sectional area of the tapered portion 150 adjacent the wide end 238 of the frustoconical portion 224.

A cup shaped diffuser endcap 250 is fixedly attached to the narrow end 240 of the frustoconical portion 224 of the body portion 220. The diffuser endcap 250 includes an open end 252 and a closed end 254. The open end 252 of the diffuser endcap 250 is fixedly attached to the narrow end 240 of the frustoconical portion 224 of the body portion 220. FIG. 4 illustrates the open end 252 of the diffuser endcap 250 welded to the narrow end 240 of the frustoconical portion 224 of the body portion 220. An end wall 260 forms the closed end 254 of the diffuser endcap 250.

A diffuser passage 262 is located within the diffuser endcap 250. The diffuser passage 262 is disposed adjacent to the second end 104 of the chamber 110 of the container 38 so that fluid communication between the diffuser passage and the chamber is possible, as described below. An inner surface 264 of a tubular side wall 266 of the diffuser endcap 250 defines the radial extent of the diffuser passage 262. Radial flow passages 268 extend radially from the diffuser passage 262 through the tubular side wall 266. FIG. 4 illustrates two of the radial flow passages 268.

A metal burst disk 128 of the inflator 12b closes the diffuser passage 262 so as to prevent fluid 112 from exiting the chamber 110 through the diffuser passage 262 and the radial flow passages 268. The metal burst disk 128 has a cross-sectional area that is approximately equal to the cross-sectional area of the tapered portion 150 of the chamber 110 adjacent the narrow end 240 of the frustoconical portion 224 of the body portion 220 of the container 38. The burst disk 128 has a domed central portion 130 and a radially outwardly extending flange portion 132 that is affixed to the open end 252 of the diffuser endcap 250. Preferably, the burst disk 128 is welded to the open end 252 of the diffuser endcap 250.

The burst disk 128 is designed to rupture when acted upon by a shock wave produced from actuation of the initiator 116. The inner surface 244 of the frustoconical portion 224 of the body portion 220 of the container 38, by decreasing the cross-sectional area of the chamber 110 in the tapered portion 150, acts to increase the intensity of the shock wave and to direct the shock wave into the burst disk 128. The shock wave ruptures the domed central portion 130 of the burst disk 128 and creates a flow opening (not shown) in the burst disk. Fluid 112 flows through the flow opening in the burst disk 128, into the diffuser passage 262, and through the radial flow passages 268 to exit the inflator 12b.

From the above description of the invention, those skilled in the art will perceive improvements, changes, and modifications. For example, the dimensional relationships between various parts of the inflators described with reference to FIGS. 2-4 are for exemplary purposes only. Modification of an inflator to varying the dimensional relationships of its various parts, such as, for example, varying the angle of the tapered inner surface 188 of the inflator 12a of FIG. 3, and other improvements, changes and modifications within the skill of the art are intended to be covered by the appended claims.

Having described the invention, I claim the: following:

1. An inflator comprising:
a container having a fluid storage chamber, the chamber including opposite first and second ends;
a fluid stored under pressure in the chamber;
a shock wave generator located adjacent the first end of the chamber, the shock wave generator, when actuated, producing a shock wave that propagates through the chamber toward the second end;
a fluid outlet passage located at the second end of the chamber; and
a burst disk closing the outlet passage,
the chamber gradually decreasing in cross-sectional area adjacent the second end so that the shock wave produced by actuation of the shock wave generator is directed against the burst disk and ruptures the burst disk, thus enabling fluid flow out of the chamber through the outlet passage.

2. The inflator of claim 1 further including a device that is inserted into the container for gradually decreasing the cross-sectional area of the chamber adjacent the second end.

3. The inflator of claim 2 wherein the device including an inner surface that defines a tapered portion of the chamber, the tapered portion of the chamber narrowing toward the second end of the chamber.

4. The inflator of claim 3 wherein the burst disk includes a peripheral portion for attaching the burst disk to the container and a central portion for closing the passage, the device including an opening that is located adjacent the burst disk and that has a cross-sectional area approximately equal to the cross sectional area of the central portion of the burst disk.

5. The inflator of claim 1 wherein the container includes a diffuser endcap, the outlet passage being located in the diffuser endcap, the diffuser endcap further including an inner surface that defines a tapered portion of the chamber, the inner surface of the diffuser endcap gradually decreasing the cross-sectional area of the chamber adjacent the second end.

6. The inflator of claim 5 wherein the cross-sectional area of the chamber adjacent the second end is approximately equal to a cross-sectional area of the burst disk.

7. The inflator of claim 1 wherein the inflator includes a body portion having an inner surface that defines a tapered portion of the chamber, the inner surface of the body portion gradually decreasing the cross-sectional area of the chamber adjacent the second end.

8. The inflator of claim 7 wherein the cross-sectional area of the chamber adjacent the second end is approximately equal to a cross-sectional area of the burst disk.

9. The inflator of claim 1 wherein the gradually decreasing cross-sectional area of the chamber adjacent the second end increases an intensity of the shock wave.

10. The inflator of claim 1 wherein the fluid includes at least one inert gas and is free of any heat generating elements.

11. An inflator comprising:
a container having a fluid storage chamber and a fluid outlet passage connected to the chamber;
a burst disk closing the outlet passage;
a fluid stored under pressure in the chamber; and
means for rupturing the burst disk consisting of a shock wave generator for producing a shock wave to rupture the burst disk and means for focusing the shock wave against the burst disk.

12. The inflator of claim 11 wherein the chamber has opposite first and second ends, the outlet passage connecting to the second end of the chamber, the shock wave generator being located at the first end of the chamber and the means for focusing the shock wave being located at the second end of the chamber.

13. The inflator of claim 11 wherein the means for focusing the shock wave includes a device that is inserted into the container, the device including an inner surface that gradually decreases a cross-sectional area of the chamber adjacent the second end.

14. The inflator of claim 11 wherein the means for focusing the shock wave includes an inner surface of a diffuser endcap of the container, the inner surface gradually decreasing a cross-sectional area of the chamber adjacent the second end.

15. The inflator of claim 11 wherein the means for focusing the shock wave includes an inner surface of a body portion of the container, the inner surface of the body portion gradually decreasing a cross-sectional area of the chamber adjacent the second end.
